(19) United States
(12) Patent Application Publication
(10) Pub. No.: US 2026/0170084 A1
(43) Pub. Date: Jun. 18, 2026

(54) MATRIX TRANSPOSITION APPARATUS

(71) Applicant: Electronics and Telecommunications Research Institute, Daejeon (KR)

(72) Inventor: Ki Hyuk PARK, Daejeon (KR)

(73) Assignee: Electronics and Telecommunications Research Institute, Daejeon (KR)

(21) Appl. No.: 19/424,276

(22) Filed: Dec. 18, 2025

(30) Foreign Application Priority Data
Dec. 18, 2024 (KR) 10-2024-0190394
Aug. 28, 2025 (KR) 10-2025-0121525

(51) Int. Cl. G06F 17/16; G06F 7/78

(52) U.S. Cl. CPC G06F 17/16; G06F 7/78

(57) ABSTRACT

The present invention relates to a matrix transposition apparatus including a matrix transposition circuit with a pipeline structure including a plurality of transposed cells, an input data interface configured to input data of each row of a matrix into the matrix transposition circuit according to a size of a matrix input to the matrix transposition circuit, an output multiplexing part configured to selectively output output data of the matrix transposition circuit according to the size of the matrix, and an output data interface configured to output the output data output from the output multiplexing part in a form of a transposed matrix according to the size of the matrix.

### CROSS-REFERENCE TO RELATED APPLICATION

This application claims priority to and the benefit of Korean Patent Application No. 10-2024-0190394, filed on Dec. 18, 2024, and Korean Patent Application No. 10-2025-0121525, filed on Aug. 28, 2025, the disclosure of which are incorporated herein by reference in their entirety.

### BACKGROUND

### 1. Field of the Invention

The present invention relates to a matrix transposition apparatus.

### 2. Discussion of Related Art

Data processing devices, such as central processing units (CPUs), graphics processing units (GPUs), and the like, support various application programs and should perform a data arithmetic operation for each program operation.

As an example of the data arithmetic operation, in order to perform a two-dimensional (2D) digital filter or a 2D fast Fourier transform, since data to be processed is massive, a transpose of a 2D matrix is required essentially. In addition, in the case of a synthetic aperture radar (SAR) or an unmanned aerial vehicle (UAV), which is a technology for mathematically reconstructing and visualizing radar information observed over a wide area by aircraft or satellites, data that should be processed with a 2D digital filter is massive and requires real-time processing, and thus a transpose of a data matrix is essential, and performance of the matrix transposition algorithm has a significantly impact on the performance of a system.

Meanwhile, a matrix transposition circuit of a pipeline structure may be used as a transposition matrix that performs the transposition of a data matrix. However, since the matrix transposition circuit has a fixed size, when matrix data of a small size is processed, there is a problem that the same processing delay occurs as in the matrix transposition circuit.

### SUMMARY OF THE INVENTION

The present invention is directed to providing a matrix transposition apparatus that enables a matrix transposition circuit to perform transposition on matrix data of various sizes.

A matrix transposition apparatus according to some embodiments of the present invention includes a matrix transposition circuit with a pipeline structure including a plurality of transposed cells, an input data interface configured to input data of each row of a matrix into the matrix transposition circuit according to a size of a matrix input to the matrix transposition circuit, an output multiplexing part configured to selectively output output data of the matrix transposition circuit according to the size of the matrix, and an output data interface configured to output the output data output from the output multiplexing part in a form of a transposed matrix according to the size of the matrix.

The input data interface of the present invention may input row data of the matrix to each pipeline of the matrix transposition circuit according to the size of the matrix.

The input data interface of the present invention may input row data of the matrix to the matrix transposition circuit according to an operating mode value preset according to the size of the matrix.

The output multiplexing part of the present invention may include a plurality of output multiplexers installed for each pipeline of the matrix transposition circuit and configured to selectively output the output data of the matrix transposition circuit.

The output multiplexer of the present invention may select and output any one piece of output data of each stage of the pipeline of the matrix transposition circuit.

The output multiplexer of the present invention may select and output any one piece of the output data of each stage of the pipeline according to an operating mode value preset according to the size of the matrix.

The output data interface of the present invention may combine the output data output from the output multiplexing part according to an operating mode value preset according to the size of the matrix and output the combined output data in a form of the transposed matrix.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a structural diagram of a matrix transposition apparatus according to one embodiment of the present invention;

FIG. 2 is a block diagram of a transposed cell according to one embodiment of the present invention;

FIG. 3 is a diagram illustrating an input and an output of an input data interface according to one embodiment of the present invention;

FIG. 4 is a block diagram of an output multiplexer controller according to one embodiment of the present invention;

FIG. 5 is a diagram illustrating an input and an output of the output multiplexer controller according to one embodiment of the present invention; and

FIG. 6 is a diagram illustrating an input and an output of an output data interface according to one embodiment of the present invention.

### DETAILED DESCRIPTION OF EXEMPLARY EMBODIMENTS

Hereinafter, embodiments of a matrix transposition apparatus according to one embodiment of the present invention will be described. In this process, the thickness of lines and the size of components illustrated in the drawings may be exaggerated for clarity and convenience of description. In addition, terms used below are defined in consideration of the functions thereof in the present invention and may vary depending on the intention of a user or an operator or common practice. Therefore, these terms should be contextually defined in light of the present specification.

The present invention may be implemented in various different forms, and thus it is not limited to embodiments to be described herein. In the drawings, some portions not related to the description will be omitted in order to clearly describe the present invention, and similar reference numerals are given to similar components throughout this disclosure.

Throughout the present specification, when a part is referred to as “including” a component, this means that the part can include other elements, rather than excluding any other components unless specifically stated otherwise.

Implementations described herein may also be implemented by, for example, a method or process, an apparatus, a software program, a data stream, or a signal. Even when only discussed in the context in a single form of implementation (e.g., discussed only as a method), the implementation of features discussed may also be implemented in other forms (e.g., an apparatus or program). The apparatus may be implemented in suitable hardware, software, and firmware. The method may be implemented in an apparatus such as a processor, which is generally referred to as a processing device including, for example, a computer, a microprocessor, an integrated circuit, or a programmable logic device.

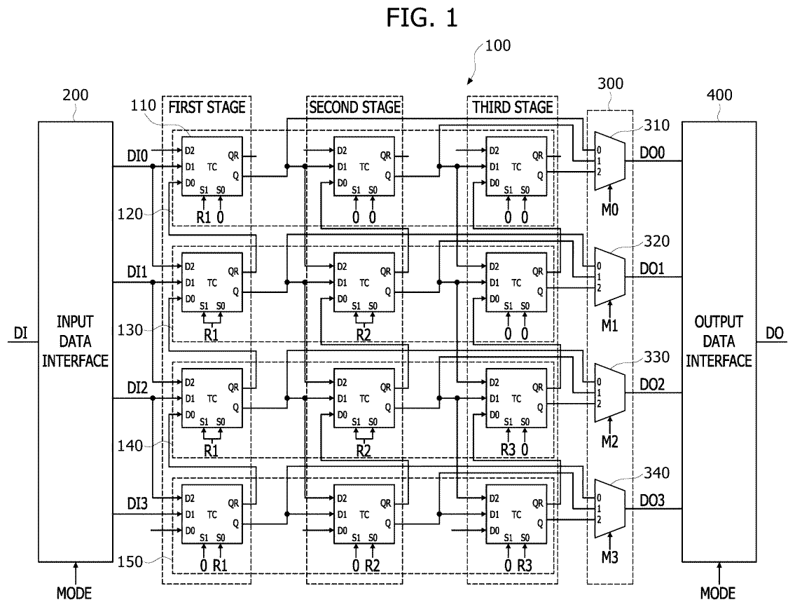

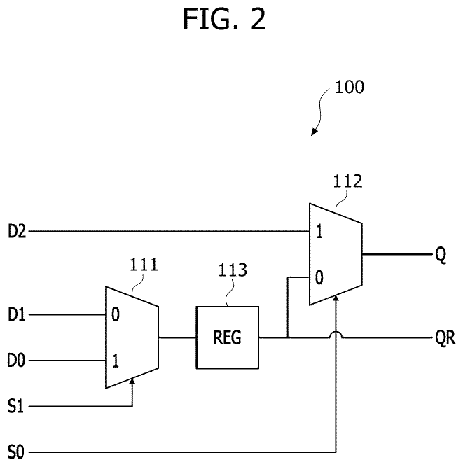

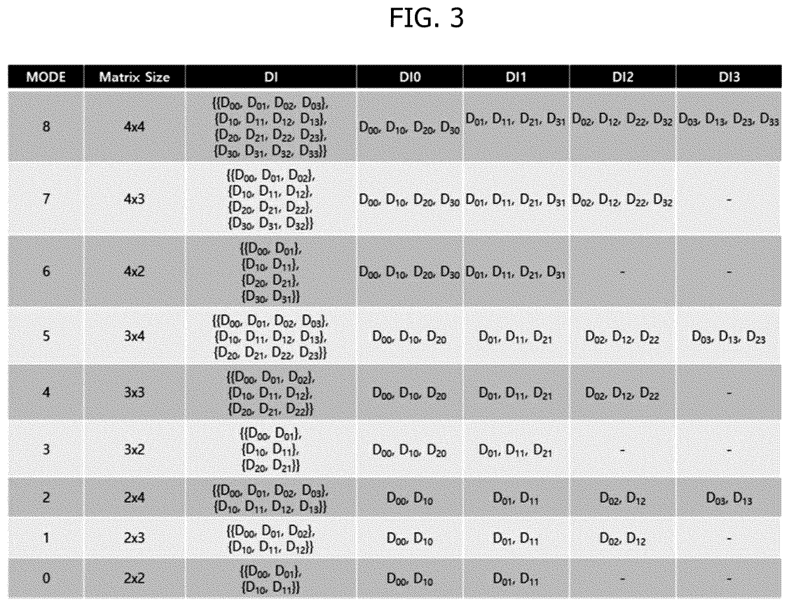

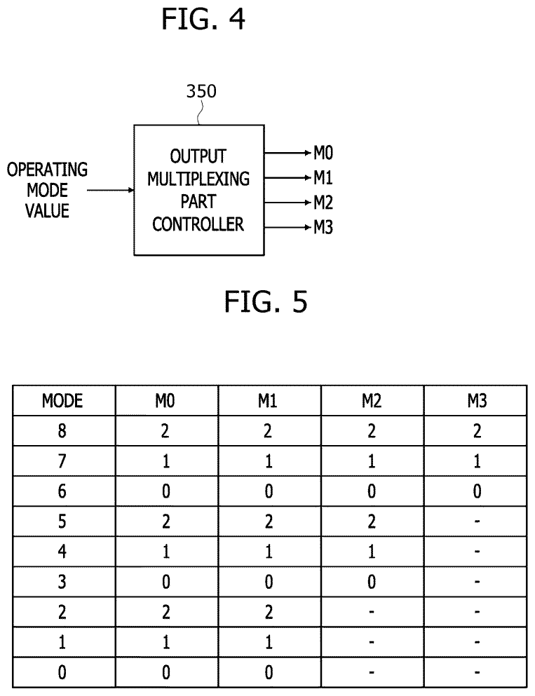

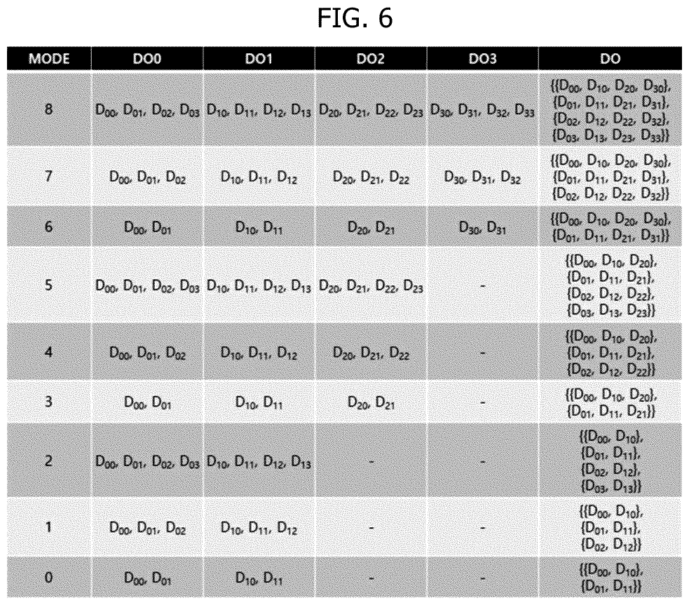

FIG. 1 is a structural diagram of a matrix transposition apparatus according to one embodiment of the present invention, FIG. 2 is a block diagram of a transposed cell according to one embodiment of the present invention, FIG. 3 is a diagram illustrating an input and an output of an input data interface according to one embodiment of the present invention, FIG. 4 is a block diagram of an output multiplexing part controller according to one embodiment of the present invention, FIG. 5 is a diagram illustrating an input and an output of the output multiplexing part controller according to one embodiment of the present invention, and FIG. 6 is a diagram illustrating an input and an output of an output data interface according to one embodiment of the present invention.

Referring to FIG. 1, the matrix transposition apparatus according to one embodiment of the present invention may include an input data interface 200 that inputs data of each row of matrix data into a matrix transposition circuit 100 according to a size of a matrix, an output multiplexing part 300 that selects and outputs data at a preset output point according to the size of the matrix, and an output data interface 400 that outputs data in a format of a transposed matrix according to the size of the matrix.

The matrix transposition circuit 100 may be an N×N matrix transposition circuit 100 with a pipeline structure, which transposes an N×N matrix. In the present embodiment, an example of the 4×4 matrix transposition circuit 100 will be described.

The 4×4 matrix transposition circuit 100 may receive four pieces of matrix data DI0, DI1, DI2, and DI3 that constitute one row of a 4×4 matrix and output 4×4 transposed matrix data D00, DO1, DO2, and DO3.

The 4×4 matrix transposition circuit 100 may include twelve transposed cells (TCs) 110 disposed in a pipeline structure.

Referring to FIG. 2, the TC 110 may include a first multiplexer (MUX) 111, a second MUX 112, and a register 113.

The first MUX 111 may receive data D1 and data D0 and output any one of the data D1 and the data D0 according to a selection signal S1. The first MUX 111 may output the data D0 when the selection signal S1 is 1 and output the data D1 when the selection signal S1 is 0.

The register 113 may store the output data of the first MUX 111. In this case, the register 113 may store any one of the data D0 and D1 selected by the selection signal S1 as a register value. The register 113 may input the stored register value into the second MUX 112.

The second MUX 112 may receive the data D2 and the register value and output any one of the data D2 and the register value as data Q according to the selection signal S0. In this case, the second MUX 112 may output the register value when the selection signal S0 is 0 and output the data D2 when the selection signal S0 is 1.

In this way, the TC 110 may finally output any one of the data D0 and D1 or bypass the first MUX 111 and the register 113 to output the data D2 according to the selection signals S1 and S0.

In the case of the 4×4 matrix transposition circuit 100, twelve TCs 110 may be provided and disposed in a pipeline structure by being mutually connected in series or in parallel. That is, three TCs 110 may be connected in series at a first pipeline 120, three TCs 110 may be connected in series at a second pipeline 130, three TCs 110 may be connected in series at a third pipeline 140, and three TCs 110 may be connected in series at a fourth pipeline 150. These first pipeline 120 to fourth pipeline 150 may be disposed in parallel. Accordingly, the 4×4 matrix transposition circuit 100 may output 4×4 transposed matrix data DO0, DO1, DO2, and DO3 through parallel data processing for the matrix data DI0, DI1, DI2, and DI3.

The 4×4 matrix transposition circuit 100 may be divided into a first stage to a third stage based on an output time point for a timing. R1, R2, R3, and 0 may be input to the first to third stages according to the selection signals S1 and S0. R1 and 0 may be input as the selection signals S1 and S0 in the first stage, R2 and 0 may be input as the selection signals S1 and S0 in the second stage, and R3 and 0 may be input as the selection signals S1 and S0 in the third stage. Here, each of R1, R2, and R3 may be 1 or 0, and appropriate values should be input such that the matrix data may be transposed through the pipelines.

The selection signals R1 and R2 may be 1 or 0 at each timing. That is, 0 may be input to R1 at a first timing (t=0), 1 may be input to R1 and 0 may be input to R2 at a second timing (t=1), 1 may be input to R1, 1 may be input to R2, and 0 may be input to R3 at a third timing (t=2), 1 may be input to R1, 1 may be input to R2, and 1 may be input to R3 at a fourth timing (t=3), 0 may be input to R1, 0 may be input to R2, and 0 may be input to R3 at a fifth timing (t=4), 0 may be input to R2 and 0 may be input to R3 at a sixth timing (t=5), and 0 may be input to R3 at a seventh timing (t=6). Accordingly, the output data (data Q) of the TC 110 in the first stage may be input as input data (the data D1 and D2) of the TC 110 in the second stage, the output data (data Q) of the cell in the second stage may be input as input data (the data D1 and D2) of the TC 110 in the third stage, and the output of each TC 110 in the third stage may output the final 4×4 transposed matrix data DO0, DO1, DO2, and DO3.

In this way, as 1 and 0 are selectively input to the selection signals S1 and S0 of each TC 110 in the first to third stages, the four pieces of matrix data DI0, DI1, DI2, and DI3 may be shifted through each TC 110 in the first to third stages and may be output as the 4×4 transposed matrix data DO0, DO1, DO2, and DO3. That is, the 4×4 matrix transposition circuit 100 may shift the four pieces of matrix data DI0, DI1, DI2, and DI3 that constitute one row of a 4×4 matrix based on the pipeline structure and output the final 4×4 transposed matrix data DO0, DO1, DO2, and DO3 by one row at a time. Here, the 4×4 matrix transposition circuit 100 is obvious to those skilled in the art, and thus a detailed description will be omitted herein.

The input data interface 200 may input data of each row of matrix data into the pipelines 120, 130, 140, and 150 of the 4×4 matrix transposition circuit 100 according to a preset operating mode value.

Referring to FIG. 3, an operating mode value may be set according to a size of a matrix input to the 4×4 matrix transposition circuit 100.

The size of the matrix may be any one of 2×2, 2×3, 2×4, 3×2, 3×3, 3×4, 4×2, 4×3, and 4×4, which is input to the 4×4 matrix transposition circuit 100, and the operating mode value may be set to any one of 0 to 8 for the size of each matrix.

The input data interface 200 may selectively allocate row data of a corresponding matrix to the matrix data DI0, DI1, DI2, and DI3 according to the operating mode value. For example, when the operating mode value is 0, a size of a matrix to be processed may be 2×2. In this case, when t=0, the input data interface 200 may input {D00, D01} as matrix data DI0 and DI1, and when t=1, the input data interface 200 may input {D10, D11} as matrix data DI0 and DI1.

The output multiplexing part 300 may select output data of a preset stage and output the output data according to a size of a matrix in response to control inputs M0 to M3 input from an output multiplexing part controller 350. That is, the output multiplexing part 300 may select and output any one of the output data of the first stage, the output data of the second stage, and the output data of the third stage of each of the first pipeline 120 to the fourth pipeline 150.

Referring to FIG. 4, the output multiplexing part controller 350 may output the control inputs M0 to M3 according to the operating mode value. For example, as shown in FIG. 5, when the operating mode value is 0, the output multiplexing part controller 350 may output the control input M0 as 0 and the control input M1 as 0. That is, the output multiplexing part controller 350 may selectively output any one of 0 and 2 to each of the control inputs M0 to M3 according to the operating mode value.

Referring to FIG. 4, the output multiplexing part 300 may select and output the output data of each stage (the first to third stages) of the first to fourth pipelines 120 to 150 of the matrix transposition circuit 100.

The output multiplexing part 300 may include a first output multiplexer 310, a second output multiplexer 320, a third output multiplexer 330, and a fourth output multiplexer 340.

The first output multiplexer 310 may output the 4×4 transposed matrix data DO0. The first output multiplexer 310 may be installed at an output terminal of the first pipeline 120. The first output multiplexer 310 may output any one of an output data of the first stage, an output data of the second stage, and an output data of the third stage of the first pipeline 120. Accordingly, the first output multiplexer 310 may select and output any one of the output data of the first stage, the output data of the second stage, and the output data of the third stage of the first pipeline 120 according to the control input M0 (any one of 0, 1, and 2) input from the output multiplexing part controller 350.

The second output multiplexer 320 may output the 4×4 transposed matrix data DO1. The second output multiplexer 320 may be installed at an output terminal of the second pipeline 130. The second output multiplexer 320 may output any one of an output data of the first stage, an output data of the second stage, and an output data of the third stage of the second pipeline 130. Accordingly, the second output multiplexer 320 may select and output any one of the output data of the first stage, the output data of the second stage, and the output data of the third stage of the second pipeline 130 according to the control input M1 (any one of 0, 1, and 2) input from the output multiplexing part controller 350.

The third output multiplexer 330 may output the 4×4 transposed matrix data DO2. The third output multiplexer 330 may be installed at an output terminal of the third pipeline 140. The third output multiplexer 330 may output any one of an output data of the first stage, an output data of the second stage, and an output data of the third stage of the third pipeline 140. Accordingly, the third output multiplexer 330 may select and output any one of the output data of the first stage, the output data of the second stage, and the output data of the third stage of the third pipeline 140 according to the control input M2 (any one of 0, 1, and 2) input from the output multiplexing part controller 350.

The fourth output multiplexer 340 may output the 4×4 transposed matrix data DO3. The fourth output multiplexer 340 may be installed at an output terminal of the fourth pipeline 150. The fourth output multiplexer 340 may output any one of an output data of the first stage, an output data of the second stage, and an output data of the third stage of the fourth pipeline 150. Accordingly, the fourth output multiplexer 340 may select and output any one of the output data of the first stage, the output data of the second stage, and the output data of the third stage of the fourth pipeline 150 according to the control input M3 (any one of 0, 1, and 2) input from the output multiplexing part controller 350.

The output data interface 400 may output the output data output from the output multiplexing part 300 in the form of a matrix transposed according to the size of the matrix. That is, the output data interface 400 may form and output the 4×4 transposed matrix data according to the operating mode value. For example, as shown in FIG. 6, when the operating mode value is 0 and {D₀₀, D₁₀} are output to the output data DO0 and DO1, the output data interface 400 may output to DO by combining {D₀₀, D₁₀}, and when {D₀₁, D₁₁} are output, the output data interface 400 may output to DO by combining {D₀₁, D₁₁}, thereby outputting a final 2×2 transposed matrix. In this case, DO2 and DO3 outputs are ignored. That is, the output data interface 400 may finally output the transposed matrix by combining the output data DO0, DO1, DO2, and DO3 according to the operating mode value.

In this way, the matrix transposition apparatus according to one embodiment of the present invention can process matrix data of various sizes even in a matrix transposition circuit of a fixed size, thereby minimizing a processing delay of the matrix transposition circuit.

The terms “unit, ” “part,” and/or “interface” (collectively “unit”) used in the present specification can include a unit implemented in hardware, software, or firmware and can be interchangeably used with terms, for example, including a logic, a logic block, a component, and a circuit. The “unit” may be a minimum unit or a portion thereof that performs one or more functions. For example, according to one embodiment, the unit may be implemented in the form of an application-specific integrated circuit (ASIC).

A matrix transposition apparatus according to an aspect of the present invention can process matrix data of various sizes even in a matrix transposition circuit of a fixed size, thereby minimizing a processing delay of the matrix transposition circuit.

While the present invention has been described with reference to embodiments shown in the drawings, these embodiments are merely illustrative and it should be understood that various modifications and equivalent other embodiments can be derived by those skilled in the art on the basis of the embodiments. Therefore, the technical scope of the present invention should be defined by the appended claims.

What is claimed is:

1. A matrix transposition apparatus comprising:
a matrix transposition circuit with a pipeline structure including a plurality of transposed cells;
an input data interface configured to input data of each row of a matrix into the matrix transposition circuit according to a size of a matrix input to the matrix transposition circuit;
an output multiplexing part configured to selectively output output data of the matrix transposition circuit according to the size of the matrix; and
an output data interface configured to output the output data output from the output multiplexing part in a form of a transposed matrix according to the size of the matrix.

2. The matrix transposition apparatus of claim 1, wherein the input data interface inputs row data of the matrix to each pipeline of the matrix transposition circuit according to the size of the matrix.

3. The matrix transposition apparatus of claim 1, wherein the input data interface inputs row data of the matrix to the matrix transposition circuit according to an operating mode value preset according to the size of the matrix.

4. The matrix transposition apparatus of claim 1, wherein the output multiplexing part includes a plurality of output multiplexers installed for each pipeline of the matrix transposition circuit and configured to selectively output the output data of the matrix transposition circuit.

5. The matrix transposition apparatus of claim 4, wherein the output multiplexer selects and outputs any one piece of output data of each stage of the pipeline of the matrix transposition circuit.

6. The matrix transposition apparatus of claim 5, wherein the output multiplexer selects and outputs any one piece of the output data of each stage of the pipeline according to an operating mode value preset according to the size of the matrix.

7. The matrix transposition apparatus of claim 1, wherein the output data interface combines the output data output from the output multiplexing part according to an operating mode value preset according to the size of the matrix and outputs the combined output data in a form of the transposed matrix.
